(19) United States
(12) Patent Application Publication
(10) Pub. No.: US 2015/0248660 A1
(43) Pub. Date: Sep. 3, 2015

(54) COMMUNICATIONS SYSTEM AND METHOD FOR AN AIRCRAFT

(71) Applicant: LUFTHANSA TECHNIK AG, HAMBURG (DE)

(72) Inventor: Andrew Muirhead, Norderstedt (DE)

(21) Appl. No.: 14/432,380

(22) PCT Filed: Sep. 26, 2013
(86) PCT No.: PCT/EP2013/070112

§ 371 Date: Mar. 30, 2015

(30) Foreign Application Priority Data
Sep. 28, 2012 (DE) 10 2012 217 808.2

(51) Int. Cl. G06Q 20/22; G06Q 20/32; H04B 5/00

(52) U.S. Cl. CPC G06Q 20/22; H04B 5/0025; G06Q 20/3278

(57) ABSTRACT

The invention concerns a communications system and a corresponding communications method for an aircraft, the aircraft comprising a central data-processing arrangement. The communications system comprises at least one communications terminal which is allocated to a particular seat in the aircraft. The communications terminal has a wireless and/or cable-bound data connection to the central data-processing arrangement. The communications terminal comprises a communications interface which is arranged to determine and/or exchange payment data from a passenger appliance and/or a passenger transponder element. The payment data from the communications terminal can be transmitted to the central data-processing arrangement, the central data-processing arrangement being arranged to allocate the payment data to the respective seat and/or to the respective passenger appliance and/or to the respective passenger transponder element.

The invention relates to a communication system for an airplane, wherein the airplane has a central data processing system, wherein the communication system comprises at least one communication terminal, which is assigned to a certain seat in the airplane, wherein the communication terminal has a wireless and/or hard-wired data link to the central data processing system. In addition, the invention relates to a corresponding communication method.

Passengers on commercial airplanes are regularly offered various additional goods and services by the cabin crew on the airplane during the flight. Such goods may include, for example, small gifts or duty-free goods, depending on the route of the flight. Services may include, for example, special meals or beverages served by the cabin crew.

The corresponding payment processes for paying for the corresponding goods and services may include cash or the usual card payments with debit cards or credit cards, where these transactions are completed with the help of mobile readers, which are used by the cabin crew for reading out the card data. These mobile readers typically yield a corresponding printout that contains the necessary payment data and is signed by the passenger. The signatures can be compared by the cabin crew with the signature on the debit or credit card. As an alternative to such an in-flight payment, certain in-flight services can also be booked in advance.

Cash payments are not convenient because of the large number of possible currencies, and the cabin crew must also keep enough change on hand in the various currencies. Card payments using debit or credit cards require the deployment of personnel of the cabin crew and are inefficient to handle for multiple smaller payments by a passenger. Payment for services in advance shifts the payment process accordingly but results in less flexibility because the wishes of a passenger may change during the flight in accordance with the passenger's mood and physical condition, so that the desired goods and services desired at short notice cannot be settled with said advance payment process. Payment on account at a later date is not always desired by the airline companies because of the international destinations and the associated low enforceability of payment demands.

If the services involve electronic offers on board the airplane, then, with the usual payment methods, assignment of the order and the payment to a certain passenger is subject to errors because these must be handled by the cabin crew. In particular, more frequent payment with smaller amounts each time is not economical to handle for on-board electronic offers.

The object of the invention is to simplify payment processes in an airplane.

Starting from the preamble of claim 1, the object of the invention is achieved by using its characterizing features. A communication system for an airplane is proposed, wherein the airplane has a central data processing system. The communication system includes at least one communication terminal, which is assigned to a certain seat in the airplane, wherein the communication terminal has a wireless and/or hard-wired data link to the central data processing system. According to the invention, the communication terminal has a communication interface, which is set up to detect and/or exchange payment data from a passenger device and/or a passenger transponder element, preferably securely. In addition, the payment data can be transferred from the communication terminal to the central data processing system, wherein the central data processing system is set up to assign the payment data to the respective seat and/or the respective passenger device and/or the respective passenger transponder element.

A communication terminal which is assigned to a certain seat permits payment by the passenger at his seat without requiring support by the cabin crew. Numerous payment operations, in particular also those with smaller amounts, can be handled during the flight in this way. The payment data can be detected directly at the seat, so that a purchase at short notice on-board the cabin is made possible and can be handled easily. The payment data may be stored in a passenger transponder element such as bank cards, for example, in particular in the ISO/IEC 7810 ID-1 format, or in an electronic device belonging to the passenger, said device having been carried on during the flight and set up accordingly.

The payment data may thus be detected in parallel for a plurality of passengers during a flight, wherein the transmission to a central data processing system in the airplane is advantageous in order to be able to assign the payment data for the additional use to the respective seat, passenger device and/or so passenger transponder element and therefore to the passenger. This makes it possible to render services or even supply goods at the passenger's seat in a simple manner.

Passenger devices may include cell phones or portable computers as well as any mixed form of these two devices, such as smartphones, for example, or tablet PCs. The passenger devices are brought on the airplane by the passengers on a flight, where they can be used by the passengers. The passenger devices can be used by the passengers during the flight for entertainment or for work.

The communication interface preferably comprises a near field communication (NFC) interface, for example, according to the ISO/IEC 13157 standard or a comparable standard. A near field communication interface permits non-contact and non-hackable transmission of payment data from a passenger device and/or a passenger transponder element to the communication interface. The communication interface can be integrated easily into the backrest of a front seat because of the non-contact transmission, which is limited to a few centimeters. In addition, the non-contact transmission permits a closed surface, which is protected from mechanical manipulations or damage, e.g., by children, during the flight in contrast with a conventional card reader.

The central data processing system preferably has a connection to an on-board entertainment system, wherein media offers, data transfer quotas, wireless network accesses and/or telephone connections of the on-board entertainment system can be enabled by means of the detected and/or exchanged payment data for at least one seat in the airplane. The electronic offers on board the airplane can be enabled easily and directly for the corresponding passenger at his seat after a payment operation has been concluded in this way, without requiring any manual intervention on the part of the cabin crew. The passenger can thus consume, for example, media content of an on-board entertainment system, such as films, music and/or games, directly at his seat after payment at the communication terminal.

In addition, access to a data network on the airplane can be enabled for the passenger through the data processing system by means of the communication terminal at the passenger's seat and/or by means of his passenger device.

The data network on the airplane may be a wireless network, for example. The data network on the airplane can be connected to an external communication system, wherein the external communication system on the airplane may go beyond the capabilities of the usual passenger devices in particular with respect to range, so that continuous access to the Internet during the flight is possible. The transmitted data volume can be monitored, so that only the data transfer volumes and/or quotas for which payment has been made are enabled for the respective passenger. The telephone connections, in particular those to passenger devices, can be established in the same way as the data transfer volume, through an assignment of the payment operation to a passenger device, which is identified by the telephone number, for example.

In a preferred embodiment, the central data processing system may connect or disconnect at least one power supply connection for a passenger device. On-board power supply connections for use by the passenger may be present at the seat, so that the passenger can operate various electronic devices on board during the flight or during his stay on board. This can also include, for example, charging the mobile passenger device. Such access to electric power may be made available individually as a service for a passenger at his seat through the communication system accordingly, so that only passengers who want to use such a power supply connection will pay for such a connection. The data processing system may therefore connect or disconnect a corresponding power supply connection, based on payment data. The data processing system therefore preferably has a corresponding control connection to the power supply system in the cabin. Control of the power supply connection may optionally also take place by way of a corresponding control device.

The amount of electricity acquired by means of the power supply connection is advantageously detectable by the central data processing system. This allows billing for use of the power supply connection in the airplane depending on the actual power consumption. In addition, small amounts of electricity may be made available to the passenger for free, for example, for charging a cell phone, and payment may be required only when a certain amount of power level has been exceeded, for example, for continuous operation of a laptop.

In an advantageous embodiment, the data link between the communication terminal and the central data processing system can be established via an electric power supply line on the airplane. This makes it possible to avoid an additional data line, wherein the transmission of the payment data from the communication terminal to the data processing system is protected by the hard-wired transmission from improper attacks by hacking by other passenger devices in the cabin. In parallel with the data link over the power supply line, the communication terminal may have, for example, a wireless data link over a wireless network, in particular WLAN, to the data processing system.

The payment data can preferably be transmitted to a ground station over an external data link. The payment processes can be billed during the flight based on the payment data in this way. In addition, the data can be verified during the flight in this way, so that misuse can be prevented. Alternatively or additionally, the payment data can be transmitted over the external data link, for example, over a mobile wireless network, when the airplane has landed.

In addition, the object of the invention is achieved, starting from the preamble of claim 8, with the characterizing features thereof. To achieve this object, a communication method for an airplane is proposed, wherein, according to the invention, payment data from a passenger device and/or a passenger transponder element is detected and/or exchanged by at least one communication terminal with a communication interface in the airplane, which is assigned to a certain seat. The payment data is transmitted from the communication terminal to a central data processing system on the airplane, and the central data processing system assigns the payment data to the respective seat and/or the passenger device and/or the respective passenger transponder element.

The communication method permits a simple payment operation, in particular for services made available to the passenger in the airplane by means of an electronic system. The detection and/or exchange of payment data with the communication terminal and the passenger device and/or the passenger transponder element preferably take(s) place by means of near field communication in the communication method.

Verification of the payment data is preferably performed in a ground station. Verification of payment data is advantageous for a simple, secure and misuse-free payment process because the payment data determined in the airplane is present in and/or by means of a ground station belonging to the airline company and/or a financial institution.

The result of the verification is preferably transmitted to the airplane over the external data link. A simple and verified payment process can be performed in this way during a flight by using this communication method. When verification is inadequate, the services on board the airplane cannot be implemented for a passenger having inadequate verification, so that a financial loss can be prevented.

The invention will be illustrated below on the basis of preferred embodiments with reference to the accompanying figures, in which:

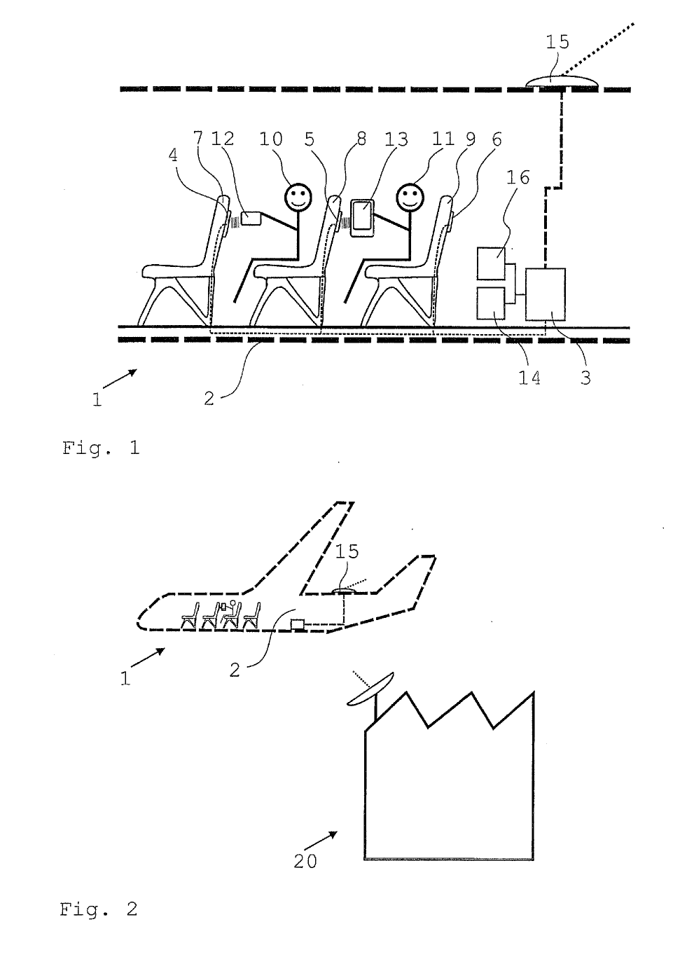

FIG. 1 shows a communication system for an airplane;

FIG. 2 shows a communication system with a ground station; and

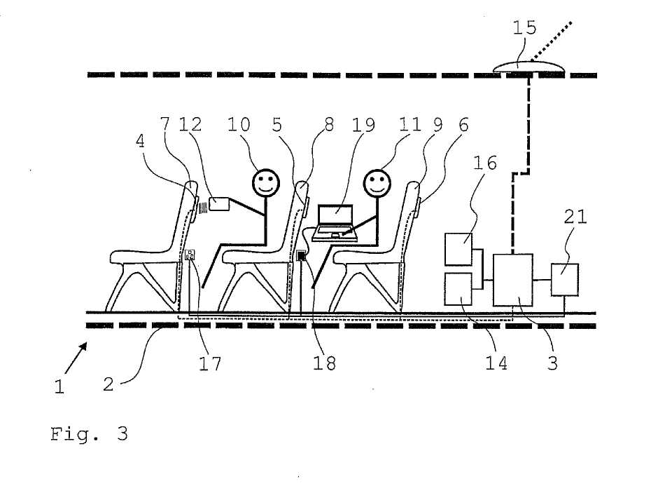

FIG. 3 shows a communication system with power supply connections at the seats.

FIG. 1 shows an advantageous embodiment of a communication system 1 for an airplane 2. The communication system 1 has a data processing system 3 in the airplane 2, wherein three communication terminals 4, 5, 6 at the seats 7, 8, 9 are connected to the data processing system 3 in this embodiment. The communication terminals 4, 5, 6 are each assigned to certain seats 7, 8, 9, wherein the communication terminals 4, 5 are assigned to the respective seats 8, 9 arranged behind them in this embodiment, although the communication terminals 4, 5 are installed on the backrest of another seat 7, 8.

The passengers 10, 11 sit in the seats 8, 9 and transmit their payment data for purchase of a service on board over the communication terminals 4, 5 to the data processing system 3.

In an advantageous embodiment, the transmission takes place as a wireless transmission by means of a near field communication (NFC) with a limited range, preferably <10 cm, for example, according to the ISO/IEC 13157 standard or a comparable standard. For this purpose, the communication terminal has a corresponding near field communication interface. In an advantageous embodiment, this near field communication interface conforms to the usual standards for transmission of payment data by means of NFC.

In this embodiment, the passenger 10 uses a passenger transponder element 12, which may be, for example, a bank card having a near field communication functionality, also known as NFC. The payment data stored in the passenger transponder element 12 is transmitted by means of near field communication to the communication terminal 4.

The passenger 11 sitting behind that passenger uses a passenger device 13 for transmission of his payment data by means of near field communication to the communication terminal 5, wherein the passenger device 13 in this embodiment is a smartphone having an integrated near field communication interface.

In alternative embodiments, the payment data can be transmitted from the passenger device 13 to the communication terminal 5 by means of a cable connection.

In the data processing system 3, the payment data is assigned to the respective seat 8, 9, on which the passenger 10, 11 making a payment is sitting. In addition, the payment is assigned for the passenger 11 to his passenger device 13.

In this embodiment, the passenger 10 has selected, for example, a film on a display screen of the on-board entertainment system 14 at his seat. The film costs a certain amount, which is displayed for the passenger 10 on his screen, which is also arranged on the rear side of the seat 7, like the communication terminal 4. In possible embodiments, the communication terminal 4, 5, 6 and the part of the on-board entertainment system 14 positioned at the seat are integrated into a shared housing. The passenger 10 consents to the payment and guides his bank card, in this case a passenger transponder element 12 having near field communication, in particular an NFC-capable payment card, up to the near field communication interface of the communication terminal 4. The corresponding payment data is exchanged between the communication terminal 4 and the passenger transponder element 12. The exchange of data with the data processing system 3 of the airplane 2 can take place in parallel or subsequently. It is also possible for the data exchange to take place between the data processing system 3 and the passenger transponder element 12 and for the communication terminal 4 to serve as an exchange station. The exchange of data between the communication terminal 4, 5, 6 and the data processing system 3 can take place over a data cable by a hard-wired process. In addition, a hard-wired data transmission can also take place via an electric power supply line with carrier frequency systems. Alternatively or additionally, a wireless transmission of data may take place between the communication terminals 4, 5, 6 and the data processing system 3. For this purpose, the airplane 2 has a wireless network access point 16, which is connected to the central data processing system 3. The communication terminals 4, 5, 6 and/or the passenger devices 13, 19 can establish a wireless data link with the wireless network access point 16.

The data processing system 3 has a connection to an on-board entertainment system 14, which displays the corresponding film on the display screen of the passenger 10.

The passenger 11 would like to use Internet access during the flight with his passenger device 13. In this embodiment, the airplane 2 has a wireless network (WLAN) to which the passenger device 13 can log on. The airplane 2 can also establish an Internet connection during the flight, even at high altitudes or in remote regions, by means of an external data link 15. The external data link 15 may be a satellite connection, for example, which is associated with corresponding costs for use. In this embodiment, the passenger 11 confirms the corresponding user fee for the external data link 15 and holds his passenger device 13 at the communication terminal 5 assigned to his seat 9, where an exchange of payment data takes place between the passenger device 13 and the communication interface 5. Alternatively, there may also be an exchange of payment data between a passenger transponder element 12, e.g., an NFC-capable payment card of the passenger 11 and the communication interface 5. The payment data is transmitted to the data processing system 3, after which the passenger device 13 of the passenger 11 is enabled for use of the external data link 15 in the wireless network of the airplane 2, so that the passenger 11 can retrieve his emails, for example, during the flight. The identification of the passenger device 13 may take place with an unambiguous hardware identifier, for example, the MAC address.

FIG. 2 shows an airplane 2 with the communication system 1, wherein the data processing system 3 transmits the payment data from the payment processes involving the passengers 10, 11 to a ground station 20 with the help of the external data link 15. The ground station 20 can be operated by the airline company, for example. The payment data is used in the ground station 20 to transfer the corresponding money according to the sales of on-board goods and services to the airline company and/or the payment recipient. In an advantageous embodiment, the payment data is verified with the corresponding financial institutions, wherein the result of the verification can be transmitted to the data processing system 3 on the airplane 2, so that the payment data can be verified in the data processing system 3 during the flight, for example.

FIG. 3 shows a communication system 1 with power supply connections 17, 18 at the seats for the passengers 10, 11. In this embodiment, the passenger 10 purchases a certain amount of electricity, which he would like to consume with a device during the flight in the airplane 2, by means of his passenger transponder element 12 and the communication system 1. After transmitting the payment data to the data processing system 3, this system controls a power supply system 21 accordingly, so that the power supply connection 17 can be used.

In this embodiment, the passenger 11 carries out such a use, charging his passenger device 19, namely a laptop, at the power supply connection 18. The power supply connection 18 may have, for example, an A.C. supply voltage of 115 V and/or 230 V. In addition, the power supply voltage at the power supply connections 17, 18 may be a D.C. electric voltage of 5 V or 12 V.

In an advantageous embodiment, the amount of electricity delivered is detected by the central data processing system 3, so that the costs of the amount of electricity actually utilized can also be assigned to the proper passenger 11.

1-10. (canceled)

11. A communication system for use in an airplane having a central data processing system, comprising:
at least one communication terminal, wherein each communication terminal of the at least one communication terminal is configured to be assigned to a corresponding seat of a corresponding at least one seat in the airplane,
wherein each communication terminal of the at least one communication terminal comprises a wireless and/or hard-wired data link to a central data processing system of an airplane,
wherein each communication terminal of the at least one communication terminal comprises a communication interface, wherein the communication interface is set up to detect and/or exchange payment data from a passenger device and/or a passenger transponder element, and
wherein each communication terminal of the at least one communication terminal is configured to transmit the payment data to the central data processing system, wherein the central data processing system is set up to assign the payment data to the seat of the at least one seat corresponding to the communication terminal of the at least one communication terminal and/or to the passenger device and/or the passenger transponder element.

12. The communication system according to claim 11, wherein each communication terminal of the at least one communication terminal comprises a near field communication (NFC) interface of a corresponding one or more near field communication interfaces.

13. The communication system according to claim 11, wherein the central data processing system has a connection to an on-board entertainment system in the airplane, wherein media offers, data transfer quotas, wireless network accesses and/or telephone connections of the on-board entertainment system can be enabled for one or more of the at least one seat in the airplane by the detected and/or exchanged payment data.

14. The communication system according to claim 11, wherein the central data processing system can connect or disconnect at least one power supply connection for a passenger device.

15. The communication system according to claim 14, wherein an amount of electricity acquired via the power supply connection can be detected by the central data processing system.

16. The communication system according to claim 11, wherein the data link between the communication terminal and the central data processing system can be established by means of an electric power supply line on the airplane.

17. The communication system according to claim 11, wherein the payment data can be transmitted to a ground station over an external data link.

18. A method of communication for an airplane, comprising:
providing at least one communication terminal having a corresponding at least one communication interface in an airplane, wherein each communication terminal of the at least one communication terminal is assigned to a corresponding seat of a corresponding at least one seat in the airplane;
detecting and/or exchanging payment data from a passenger device and/or a passenger transponder element via a communication interface;
a communication terminal central data processing system on the airplane;
transmitting the payment data from the communication terminal corresponding to the communication interface to a central data processing system on the airplane; and
assigning the payment data to the respective seat and/or the passenger device and/or the respective passenger transponder element via the central data processing system.

19. The method of communication according to claim 18, further comprising:
verifying the payment data in a ground station.

20. The communication method according to claim 19, further comprising:
transmitting a result of the verification to the airplane over the external data link.

21. An airplane, comprising:
a central processing system;
at least one communication terminal, wherein each communication terminal of the at least one communication terminal is configured to be assigned to a corresponding seat of a corresponding at least one seat in the airplane,
wherein each communication terminal of the at least one communication terminal comprises a wireless and/or hard-wired data link to a central data processing system of an airplane,
wherein each communication terminal of the at least one communication terminal comprises a communication interface, wherein the communication interface is set up to detect and/or exchange payment data from a passenger device and/or a passenger transponder element, and
wherein the communication terminal is configured to transmit the payment data to the central data processing system, wherein the central data processing system is set up to assign the payment data to the seat of the at least one seat corresponding to the communication terminal of the at least one communication terminal and/or to the passenger device and/or the passenger transponder element.

22. The airplane according to claim 21, wherein each communication terminal of the at least one communication terminal comprises a near field communication (NFC) interface of a corresponding one or more near field communication interfaces.

23. The airplane according to claim 21, wherein the central data processing system has a connection to an on-board entertainment system in the airplane, wherein media offers, data transfer quotas, wireless network accesses and/or telephone connections of the on-board entertainment system can be enabled for one or more of the at least one seat in the airplane by the detected and/or exchanged payment data.

24. The airplane according to claim 21, wherein the central data processing system can connect or disconnect at least one power supply connection for a passenger device.

25. The airplane according to claim 24, wherein an amount of electricity acquired via the power supply connection can be detected by the central data processing system.

26. The airplane according to claim 21, wherein the data link between the communication terminal and the central data processing system can be established by means of an electric power supply line on the airplane.

27. The airplane according to claim 21, wherein the payment data can be transmitted to a ground station over an external data link.
